(19) United States
(12) Patent Application Publication
(10) Pub. No.: US 2007/0198425 A1
(43) Pub. Date: Aug. 23, 2007

(54) Method and system for auditing digital rights in a content management system

(75) Inventors: Glenn Edwards Brew, Boca Raton, FL (US); James Christopher Mahlbacher, Lake Worth, FL (US); Joseph Cesare Polimeni, Parkland, FL (US)

Correspondence Address: SAWYER LAW GROUP LLP, P.O. BOX 51418, PALO ALTO, CA, 94303, US

(73) Assignee: International Business Machines Corporation, Armonk, NY (US)

(21) Appl. No.: 11/357,673

(22) Filed: Feb. 17, 2006

(51) Int. Cl. G06Q 99/00

(52) U.S. Cl. 705/57

(57) ABSTRACT

The method includes receiving digital content, determining whether the digital content has been previously protected in accordance with a digital rights management system, and if the digital content has not been previously protected then storing the digital content in the content management system. Otherwise, the method further includes extracting a first right associated with the digital content, and comparing the first rights associated with the digital content to a second right associated with the content management system. If the first right is consistent with the second right, then the digital content is stored in the content management system. If the first right is not consistent with the second right, then corrective action is taken.

### FIELD OF THE INVENTION

The present invention relates generally to digital communications, and more particularly to digital rights management.

### BACKGROUND OF THE INVENTION

A content management system is a system that can typically manage all types of digital information (or digital content) including, for example, HTML and XML Web content, document images, electronic office documents, printed output, audio, and video. Conventional content management system (e.g., an enterprise content management system) can generally protect digital information that is sensitive or confidential to a given business. For example, users of an enterprise content management system can declare any corporate document or information as a corporate record. Once a document is declared as a corporate record, the document cannot be edited or deleted from the enterprise content management system without proper authorization. In addition, access permissions and lifecycle of the document are governed by the access permissions and lifecycle rules defined in the enterprise content management system. Thus, only authorized users, such as the records administrators, can process or manage the life cycle of the document.

In today's growing e-business world, many businesses are finding it increasingly important to not only use a content management system to manage and store digital content generated within the given enterprise, but also to manage and import digital content generated by a user using a third party client (e.g., third party software) into the enterprise content management system. Incorporating digital content generated using third party software into an enterprise content management system is a generally straightforward process similar to incorporating digital content generated within the enterprise. Users using such third party software, however, are increasingly protecting digital content using one or more (proprietary) digital rights management (DRM) systems that may be associated with the third party software. A digital rights management system generally uses applied cryptography to allow a content owner to prescribe a specific use for created content. A conventional digital rights management system is a “closed” system that does not interoperate easily with other digital rights management systems, including conventional content management systems, or non-digital rights management systems. This is a result of the fact that digital rights management systems maintain persistent control over associated digital content and if interoperability were easily achieved then content protection of the digital rights management system would be easily circumvented. Examples of digital rights management systems include Microsoft Windows® Rights Management Services (RMS) available from Microsoft Corporation of Redmond, Washington, and Adobe® LiveCycle Policy Server available from Adobe Systems Incorporated of San Jose, Calif.

Accordingly, because users (or account holders) of an enterprise content management system are increasingly protecting digital content in accordance with third party (proprietary) digital rights management (DRM) systems, incorporating such third party software-protected digital content into an enterprise content management system becomes a non-trivial task as the user may apply any number of policies to protect digital content independently of the enterprise content management system. Consequently, the policies assigned to digital content by a user may be inconsistent with policies that the enterprise content management system would apply to the same digital content.

Accordingly, what is needed is a system and method for ensuring that policies associated with protected digital content that is imported into a content management system are consistent with policies that are applied to the digital content by the content management system. The present invention addresses such a need.

### BRIEF SUMMARY OF THE INVENTION

In general, in one aspect, this specification describes a method for managing digital content in a content management system. The method includes receiving digital content, determining whether the digital content has been previously protected in accordance with a digital rights management system, and if the digital content has not been previously protected then storing the digital content in the content management system. Otherwise, the method further includes extracting a first right associated with the digital content, and comparing the first rights associated with the digital content to a second right associated with the content management system. If the first right is consistent with the second right, then the digital content is stored in the content management system. If the first right is not consistent with the second right, then corrective action is taken.

Particular implementations can include one or more of the following features. Taking corrective action can include generating an audit record if the first right is not consistent with the second right. Taking corrective action can also include generating an alert if the first right is not consistent with the second right. The alert can notify a user that the first right is not consistent with the second right. Taking corrective action can include revoking the first right associated with the digital content. Receiving digital content can include receiving digital content from a third party client. Extracting a first right associated with the digital content can include negotiating with a third party policy server. The content management system can be an enterprise content management system. The first right can be determined to be consistent with the second right if the first right is at least as secure as the second right.

In general, in another aspect, this specification describes a computer program product, tangibly stored on a computer-readable medium, for storing digital content in a content management system. The product includes instructions to cause a programmable processor to receive digital content, and determine whether the digital content has been previously protected in accordance with a digital rights management system. If the digital content had not been previously protected then the product includes instructions to store the digital content in the content management system. Otherwise, the product includes instructions to extract a first right associated with the digital content, and compare the first right associated with the digital content to a second right associated with the content management system. If the first right is consistent with the second right, then the product includes instructions to store the digital content in the content management system. If the first right is not consistent with the second right, then the product includes instructions to take corrective action.

In general, in another aspect, this specification describes a content management system including a filter engine operable to determine whether digital content received by the content management system has been previously protected in accordance with a digital rights management system, and if the digital content has been previously protected then the filter engine is further operable to extract a first right associated with the digital content. The content management system further includes a comparison engine operable to compare the first rights associated with the digital content to a second right associated with the content management system, and an audit record engine operable to take corrective action if the first right is not consistent with the second right.

Implementations may provide one or more of the following advantages. A content management system is disclosed that ensures that digital content imported into the content management system is consistent with (e.g., is at least as secures as) policies associated with the content management system.

The details of one or more implementations are set forth in the accompanying drawings and the description below. Other features and advantages will be apparent from the description and drawings, and from the claims.

### BRIEF DESCRIPTION OF SEVERAL VIEWS OF THE DRAWINGS

FIG. 1 is a block diagram of a data processing system including a content management system in accordance with one implementation of the invention.

FIG. 2 is a block diagram illustrating the content management system of FIG. 1 in accordance with one implementation of the invention.

FIG. 3 illustrates a method for receiving digital content into the content management system of FIG. 1 in accordance with one implementation of the invention.

FIG. 4 is a block diagram of a data processing system suitable for storing and/or executing program code in accordance with one implementation of the invention.

Like reference symbols in the various drawings indicate like elements.

### DETAILED DESCRIPTION OF THE INVENTION

Implementations of the present invention relates generally to digital communications, and more particularly to digital rights management. The following description is presented to enable one of ordinary skill in the art to make and use the invention and is provided in the context of a patent application and its requirements. Various modifications to implementations and the generic principles and features described herein will be readily apparent to those skilled in the art. Thus, the present invention is not intended to be limited to the implementations shown but is to be accorded the widest scope consistent with the principles and features described herein.

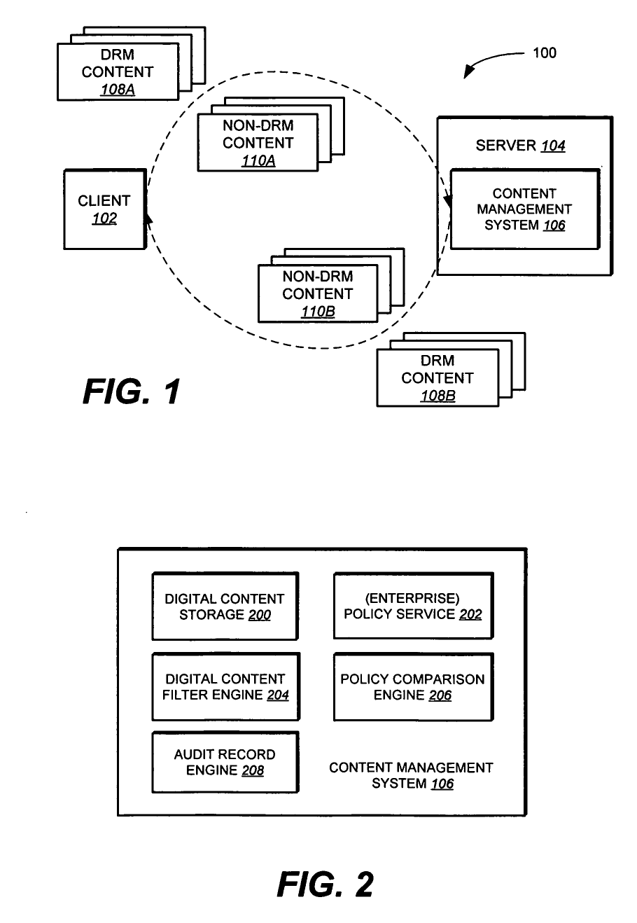

FIG. 1 illustrates a data processing system 100 including a client 102 and a server 104 in accordance with one implementation of the invention. Although data processing system 100 is shown as including one client and one server, data processing system 100 can include any number of clients and servers. Data processing system 100 can have any number and types of computer systems, including for example, a workstation, a desktop computer, a laptop computer, a personal digital assistant (PDA), a cell phone, a network, and so on. Data processing system 100 includes a content management system 106 that (in one implementation) is stored on server 104. Content management system 106 can be an enterprise software solution, such as an enterprise content management system as described in U.S. patent application entitled—“Method and Apparatus for Providing Interoperability Between Digital Rights Management Systems”, attorney docket no. SVL920050095US1/3661P, filed on even date herewith and assigned to the assignee of the present invention, which is incorporated by reference in its entirety.

In one implementation, content management system 106 is operable to receive protected digital content (e.g., DRM content 108A) and/or non-protected digital content (e.g., non-DRM content 110A) from client 102 and export protected digital content (e.g., DRM content 108B) and/or non-protected digital content (e.g., non-DRM content 11 OB) to client 102. In one implementation, content management system 106 is further operable to apply security policies (e.g., enterprise security policies) to digital content stored within content management system 106. A (security) policy includes one or more rights that govern the interaction between a user and digital content. In one implementation, content management system 106 applies security policies to digital content based on a location (e.g., a folder) in which the digital content is stored (or associated with) within content management system 106.

The security policies associated with content management system 106 (or the security policies applied by content management system 105 to the digital content stored within content management system 106) may or may not be consistent with policies or rights associated with protected digital content received by content management system 106. Accordingly, content management system 106 includes systems (discussed in greater detail below) for determining whether policies and/or rights associated with the protected digital content received by content management system 106 are consistent (or at least as secure) as the policies and/or rights that would be assigned to digital content by content management system 106. For example, if content management system 106 includes an enterprise policy of not allowing contractors to have any “printing” rights, then content management system 106 would verify that protected digital content received by content management system 106 includes a consistent policy of not allowing contractors to have any printing rights.

FIG. 2 illustrates one implementation of content management system 106 in greater detail. As shown in FIG. 2, content management system 106 includes a digital content storage 200, an (enterprise) policy service 202, a digital content filter engine 204, a policy comparison engine 206, and an audit record engine 208.

Digital content storage 200 stores protected digital content and/or non-protected digital content (e.g., digital content received from client 102 of FIG. 1). In one implementation, content management system 106 is operable to apply one or more (enterprise) policies to protect received digital content based on policies established within (enterprise) policy service 202. The policies associated with policy service 202 are generally used to protect (or control the access to) digital content (e.g., data, files, or objects) stored in content management system 106. Generally, the policies identify which users may access an object such as a file or directory, and identify the type of access that a user has for a particular object. A network manager or system operator may alter such the policies to change what data a user may have access to, the type of access available, and operations which the user is authorized to perform on accessed data. In one implementation, a system administrator assigns policies to digital content stored in digital content storage 200 using (access) permission bits that, for example, can control who can read or write a particular file.

In one implementation, digital content filter engine 204 determines if digital content received by content management system has been previously protected by, for example, a user using a third party client (or third party software). In one implementation, digital content filter engine determine whether digital content has been previously protected in accordance with a digital rights management system using methods as described in U.S. patent application entitled—“Method and Apparatus for Providing Interoperability Between Digital Rights Management Systems”, incorporated by reference above. Conventional methods for determining if digital content has been previously protected, including which type of digital protection has been applied, can also be implemented by digital content filter engine 204.

In one implementation, digital content filter engine 204 is further operable to extract the (e.g., third party software) policies and/or rights from protected digital content. In one implementation, the credentials required to permit content management system 106 to extract the policies and/or rights from protected digital content are established prior to deployment of content management system 106. In this implementation, content management system 106 is granted ownership rights (e.g., as a transferring broker) to protected digital content from all digital rights management systems supported by content management system 106. The granted ownership in the protected digital content, therefore, permits content management system to extract the policies and/or rights from the protected digital content. In one implementation, content management system 106 negotiates with a policy server of a third party client to extract policies and/or rights associated with protected digital content.

In one implementation, policy comparison engine 206 compares the policies and/or rights associated with protected digital content to policies and/or rights associated with content management system 106—e.g., the policies and/or rights associated with policy service 202. Policy comparison engine 206 is operable to determine whether the policies and/or rights associated with protected digital content are consistent or at least as secure (or strong) as the policies and/or rights specified for the particular type of digital content by policy service 202. In one implementation, audit record engine 208 is operable to take corrective action if the policies and/or rights associated with protected digital content are not consistent with the policies and/or rights specified for the particular type of digital content. Accordingly, in one implementation audit record engine 208 operable to generate an audit record if the policies and/or rights associated with protected digital content are not as secure as the policies and/or rights specified for the particular type of digital content by policy service 202. The audit record provides an audit trail so that users of content management system 106 can be assured that policy enforcement is consistently applied to digital content stored in content management system 106. Audit record engine 208 can also generate an alert that is sent to a system administrator (e.g., in the form of an e-mail or other notification method) that informs the system administrator of the particular protected digital content that is not consistent with the policies and/or rights associated with content management system 106. Audit record engine 208 can further take corrective action by revoking the (inconsistent) policies and/or rights associated with the digital content.

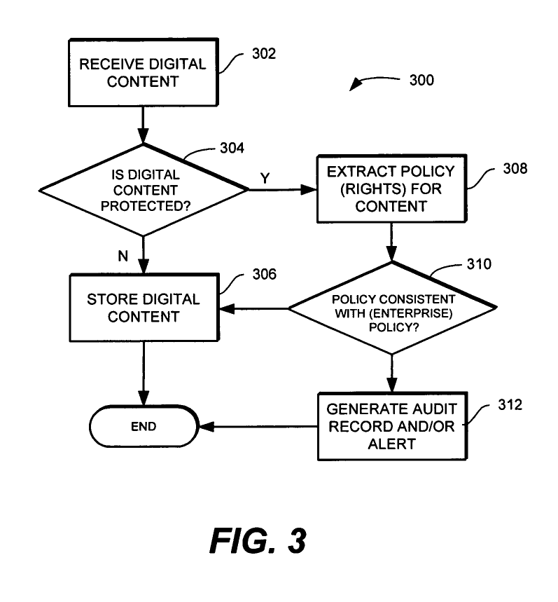

FIG. 3 illustrates a method 300 for importing digital content into a content management system (e.g., content management system 106). Digital content is received (step 302). In one implementation, the digital content is received by the content management system from a user using a client (e.g., client 102 of FIG. 1). The client can be a client application associated within an enterprise with the content management system, or the client can be a third party client application relative to the content management system. In addition, the received digital content can be DRM protected or non-DRM protected. A determination is made (e.g., by digital content filter engine 204) as to whether the digital content is DRM protected (step 304). Conventional methods for determining whether digital content is DRM protected can be implemented. If the digital content is non-DRM protected—i.e., if the digital content hasn't been previously protected by a digital rights management system—then the non-DRM protected content is stored in a digital content storage (e.g. digital content storage 200) (step 306). The content management system is operable to apply policies and/or rights to the digital content stored in the digital content storage.

If it is determined in step 304 that the digital content received by the content management system has been previously protected—i.e., the digital content is DRM-protected—then the policy and/or rights associated with the protected digital content is extracted (e.g., by digital content filter engine 204) (step 308). A determination is then made as to whether the policies and/or rights associated with protected digital content are at least as secure (or consistent with) as the policies and/or rights specified for the particular type of digital content. If the policies and/or rights associated with protected digital content are consistent with the policies and/or rights associated with the content management system, then the digital content is stored in the digital content storage associated with the content management system. If the policies and/or rights associated with protected digital content are not consistent with the policies and/or rights associated with the content management system, then (in one implementation) an audit record and/or alert is generated (e.g., by audit record engine 208) (step 312). In one implementation, the audit record provides a trail for an auditing service to review for ensuring that the - content management system is securely maintaining digital content according to pre-determined standards. Other corrective action can be taken by the content management system if the policies and/or rights associated with protected digital content are not consistent with the policies and/or rights associated with the content management system.

One or more of method steps described above can be performed by one or more programmable processors executing a computer program to perform functions by operating on input data and generating output. Generally, the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

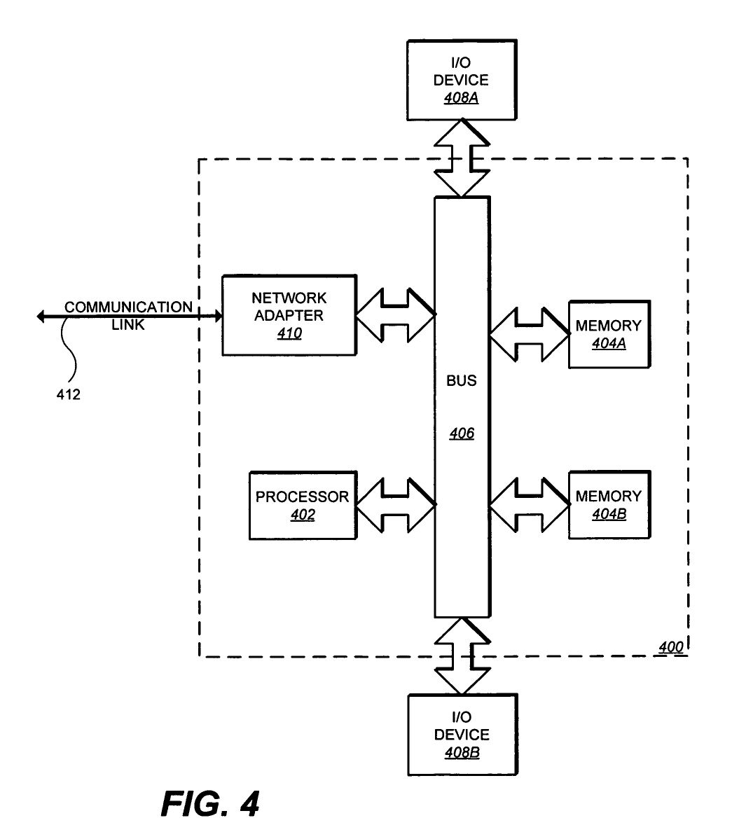

FIG. 4 illustrates a data processing system 400 suitable for storing and/or executing program code. Data processing system 400 includes a processor 402 coupled to memory elements 404A-B through a system bus 406. In other embodiments, data processing system 400 may include more than one processor and each processor may be coupled directly or indirectly to one or more memory elements through a system bus.

Memory elements 404A-B can include local memory employed during actual execution of the program code, bulk storage, and cache memories that provide temporary storage of at least some program code in order to reduce the number of times the code must be retrieved from bulk storage during execution. As shown, input/output or I/O devices 408A-B (including, but not limited to, keyboards, displays, pointing devices, etc.) are coupled to data processing system 400. I/O devices 408A-B may be coupled to data processing system 400 directly or indirectly through intervening I/O controllers (not shown).

In the embodiment, a network adapter 410 is coupled to data processing system 400 to enable data processing system 400 to become coupled to other data processing systems or remote printers or storage devices through communication link 412. Communication link 412 can be a private or public network. Modems, cable modems, and Ethernet cards are just a few of the currently available types of network adapters.

Various implementations for managing digital content in an enterprise content management system have been described. Nevertheless, one or ordinary skill in the art will readily recognize that there that various modifications may be made to the implementations, and any variation would be within the scope of the present invention. For example, the steps of methods discussed above can be performed in a different order to achieve desirable results. Accordingly, many modifications may be made by one of ordinary skill in the art without departing from the scope of the following claims.

What is claimed is:

1. A method for managing digital content in a content management system, the method comprising:
receiving digital content;
determining whether the digital content has been previously protected in accordance with a digital rights management system; and
if the digital content has not been previously protected then storing the digital content in the content management system.

2. The method of claim 1, wherein if the digital content has been previously protected, then the method further includes:
extracting a first right associated with the digital content;
comparing the first right associated with the digital content to a second right associated with the content management system; and
if the first right is consistent with the second right, then storing the digital content in the content management system,
if the first right is not consistent with the second right, then taking corrective action.

3. The method of claim 2, wherein taking corrective action includes generating an audit record if the first right is not consistent with the second right.

4. The method of claim 2, wherein taking corrective action includes generating an alert if the first right is not consistent with the second right, the alert notifying a user that the first right is not consistent with the second right.

5. The method of claim 2, wherein taking corrective action includes revoking the first right associated with the digital content.

6. The method of claim 2, wherein receiving digital content includes receiving digital content from a third party client.

7. The method of claim 2, wherein extracting a first right associated with the digital content includes negotiating with a third party policy server.

8. The method of claim 1, wherein the content management system is an enterprise content management system.

9. The method of claim 2, wherein the first right is determined to be consistent with the second right if the first right is at least as secure as the second right.

10. A computer program product, tangibly stored on a computer-readable medium, for storing digital content in a content management system, the product comprising instructions to cause a programmable processor to:
receive digital content;
determine whether the digital content has been previously protected in accordance with a digital rights management system;
if the digital content has not been previously protected then store the digital content in the content management system.

11. The product of claim 10, wherein if the digital content has been previously protected, then the product further includes instructions operable to cause a programmable processor to:
extract a first right associated with the digital content;
compare the first rights associated with the digital content to a second right associated with the content management system; and
if the first right is consistent with the second right, then the product includes instructions to store the digital content in the content management system,
if the first right is not consistent with the second right, then the product includes instructions to take corrective action.

12. The product of claim 11, wherein the instructions to take corrective action include instructions to generate an audit record if the first right is not consistent with the second right.

13. The product of claim 11, wherein the instructions to take corrective action include instructions to generate an alert if the first right is not consistent with the second right, the alert notifying a user that the first right is not consistent with the second right.

14. The product of claim 11, wherein the instructions to take corrective action include instructions to revoke the first right associated with the digital content.

15. The product of claim 11, wherein the instructions to receive digital content include instructions to receive digital content from a third party client.

16. The product of claim 11, wherein the instructions to extract a first right associated with the digital content include instructions to negotiate with a third party policy server.

17. The product of claim 10, wherein the content management system is an enterprise content management system.

18. The product of claim 11, wherein the first right is determined to be consistent with the second right if the first right is at least as secure as the second right.

19. A content management system comprising:
a filter engine operable to determine whether digital content received by the content management system has been previously protected in accordance with a digital rights management system, and if the digital content has been previously protected then the filter engine is further operable to extract a first right associated with the digital content;
a comparison engine operable to compare the first right associated with the digital content to a second right associated with the content management system; and
an audit record engine operable to take corrective action if the first right is not consistent with the second right.

20. The content management system of claim 19, wherein the audit record engine is operable to take corrective action by generating an audit record if the first right is not consistent with the second right.

21. The content management system of claim 20, wherein the audit record engine is further operable to take corrective action by generating an alert if the first right is not consistent with the second right, the alert notifying a user that the first right is not consistent with the second right.

22. The content management system of claim 19, wherein the filter engine is operable to negotiate with a third party policy server when extracting the first right associated with the digital content.

23. The content management system of claim 19, wherein the content management system is an enterprise content management system.

24. The content management system of claim 19, wherein the first right is determined to be consistent with the second right if the first right is at least as secure as the second right.
